(19) United States
(12) Patent Application Publication
(10) Pub. No.: US 2022/0366464 A1
(43) Pub. Date: Nov. 17, 2022

(54) DETERMINING A FINANCIAL ADVANCE FROM HYDROCARBON WELL ROYALTIES

(71) Applicant: Enverus, Inc., Austin, TX (US)

(72) Inventors: Phillip Dunning, Austin, TX (US); Faber Wilcox, Austin, TX (US); Stephen Masters, Austin, TX (US)

(21) Appl. No.: 17/322,121

(22) Filed: May 17, 2021

(51) Int. Cl. G06Q 30/02; G06Q 30/06; G06Q 50/06

(52) U.S. Cl. CPC G06Q 30/0283; G06Q 30/0645; G06Q 30/0641; G06Q 50/06

(57) ABSTRACT

Techniques for generating an advance on hydrocarbon royalties include determining an ownership interest in one or more hydrocarbon production wells for an entity based on at least one of payor or payee data associated with the entity; determining an identification of each hydrocarbon production well based on an associated identifier; determining an allocated hydrocarbon production volume value for each hydrocarbon production well based at least in part on lease-level hydrocarbon production volume data; determining a present monetary value for each hydrocarbon production wells based on the determined allocated hydrocarbon production volume value and a present hydrocarbon monetary value per volume unit; determining a financial offer instrument for the entity based at least in part on a sum of the determined present monetary values; and generating data that includes a representation of the determined financial offer instrument for the entity for presentation on a graphical user interface.

### TECHNICAL FIELD

This document relates to systems and methods for determining a financial advance from hydrocarbon well royalties.

### BACKGROUND

Minerals and royalties that are paid for the production of such minerals (such as oil or gas or both) are valuable assets that differ from a house or other real asset in that they are not historically underwritten. This is because, for example, uncertainty surrounding the historical and future production of such minerals, future monetary value of such minerals, and percentage ownership of royalties that often occurs. Therefore, mineral assets and royalty payments are not conventionally valued for monetary advances.

### SUMMARY

In an example implementation, a computer-implemented method performed with a computing system that includes one or more hardware processors includes determining, with the one or more hardware processors, an ownership interest in at least a portion of one or more hydrocarbon production wells for an entity based on at least one of payor data associated with the entity or payee data associated with the entity; determining, with the one or more hardware processors, an identification of each of the one or more hydrocarbon production wells based on an associated identifier of each of the one or more hydrocarbon production wells; determining, with the one or more hardware processors, an allocated hydrocarbon production volume value for each of the one or more hydrocarbon production wells based at least in part on lease-level hydrocarbon production volume data; determining, with the one or more hardware processors, a present monetary value for each of the one or more hydrocarbon production wells based on the determined allocated hydrocarbon production volume value and a present hydrocarbon monetary value per volume unit; determining, with the one or more hardware processors, a financial offer instrument for the entity based at least in part on a sum of the determined present monetary values; and generating, with the one or more hardware processors, data that includes a representation of the determined financial offer instrument for the entity for presentation on a graphical user interface (GUI).

In an aspect combinable with the example implementation, determining the ownership interest includes at least one of: identifying, with the one or more hardware processors, the payor data from a royalty payment record associated at least one payor; or identifying, with the one or more hardware processors, the payee data from a royalty payment record associated the entity.

In another aspect combinable with any one of the previous aspects, the associated identifier includes an American Petroleum Institute (API) number uniquely associated with each of the one or more hydrocarbon production wells.

Another aspect combinable with any one of the previous aspects further includes identifying, with the one or more hardware processors, the at least one of payor data associated with the entity or payee data associated with the entity from a royalty statement associated with the entity; and identifying, with the one or more hardware processors, the associated identifier of each of the one or more hydrocarbon production wells from the royalty statement associated with the entity.

Another aspect combinable with any one of the previous aspects further includes determining, with the one or more hardware processors, at least one additional payor data associated with the entity based on the at least one of payor data associated with the entity; and determining, with the one or more hardware processors, an associated identifier of at least one additional hydrocarbon production well associated with the entity based on the

In another aspect combinable with any one of the previous aspects, the determined allocated hydrocarbon production volume value for each of the one or more hydrocarbon production wells includes historical allocated hydrocarbon production volume value for each of the one or more hydrocarbon production wells.

Another aspect combinable with any one of the previous aspects further includes determining, with the one or more hardware processors, the historical allocated hydrocarbon production volume value for each of the one or more hydrocarbon production wells.

In another aspect combinable with any one of the previous aspects, determining the historical allocated hydrocarbon production volume value for each of the one or more hydrocarbon production wells includes identifying, with the one or more hardware processors, a lease identifier associated with the lease-level hydrocarbon production volume data; determining, with the one or more hardware processors, a plurality of hydrocarbon production wells associated with the lease identifier, the plurality of hydrocarbon production wells including the one or more hydrocarbon production wells; determining, with the one or more hardware processors, a decline curve model for the lease-level hydrocarbon production volume data associated with the lease identifier; modeling, with the one or more hardware processors, aggregated monthly well-level hydrocarbon production values with the determined decline curve model; and determining, with the one or more hardware processors, the historical allocated hydrocarbon production volume value for each of the one or more hydrocarbon production wells based on the aggregated monthly well-level hydrocarbon production values and the decline curve model.

In another aspect combinable with any one of the previous aspects, the determined allocated hydrocarbon production volume value for each of the one or more hydrocarbon production wells further includes predicted allocated hydrocarbon production volume value for each of the one or more hydrocarbon production wells.

In another aspect combinable with any one of the previous aspects, the decline curve model is defined, at least in part, by a maximum periodic hydrocarbon production value and at least one decline rate.

Another aspect combinable with any one of the previous aspects further includes determining, with the one or more hardware processors, the predicted allocated hydrocarbon production volume value for each of the one or more hydrocarbon production wells based at least in part on the decline curve model.

In another aspect combinable with any one of the previous aspects, determining the financial offer instrument for the entity includes executing, with the one or more hardware processors, an underwriting process.

In another aspect combinable with any one of the previous aspects, the underwriting process includes determining, with the one or more hardware processors, a loan to value (LTV) limit; determining, with the one or more hardware processors, that the sum of the determined present monetary value exceeds the LTV limit; determining, with the one or more hardware processors, that the present monetary value for any one of the one or more hydrocarbon production wells does not exceed a particular percentage of the sum of the determined present monetary values; determining, with the one or more hardware processors, that a value of the financial offer instrument does not exceed a particular percentage of an entity portfolio debt value; and determining, with the one or more hardware processors, that the underwriting process passes.

In another aspect combinable with any one of the previous aspects, generating data that includes the representation of the determined financial offer instrument for the entity is based on the determination that the underwriting process passes.

The general implementation and example aspects may also be realized in a computing system and computer-readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

One, some, or all of the implementations according to the present disclosure may include one or more of the following features. For example, implementations according to the present disclosure may identify and qualify royalty owners eligible for a royalty advance based on actual and forecasted revenue streams. As another example, implementations according to the present disclosure may tailor an offer of advance to a target prospect with actual terms to eliminate borrower confusion and/or offers that will not qualify for underwriting. As another example, implementations according to the present disclosure may provide closed-loop processing of borrower offer, application, underwriting, and fulfilment of a loan from within a single platform. As another example, implementations according to the present disclosure may provide verification of ownership decimals and revenue amounts based on actual production history. As another example, implementations according to the present disclosure may support owner-configured selections of a loan program that best fits their needs, risk profile, and repayment terms. As another example, implementations according to the present disclosure may provide for transparent underwriting assumptions to a borrower to educate the borrower on both the offer and eligibility so that the borrower can make an informed decision. As another example, implementations according to the present disclosure may communicate with operators using newly standardized agreements and forms to redirect owner payments to lender account until an advance obligation is satisfied.

The details of one or more embodiments are set forth in the accompanying drawings and the description below. Other features, objects, and advantages will be apparent from the description and drawings, and from the claims.

### DESCRIPTION OF DRAWINGS

FIG. 1 illustrates an example distributed network architecture that includes one or more client devices and one or more server devices for determining a financial advance based on hydrocarbon well royalties according to the present disclosure.

FIGS. 2A-2B illustrate flowcharts that show an example implementation of a method for determining a financial advance based on hydrocarbon well royalties according to the present disclosure.

FIG. 3 illustrates an example graphical user interface (GUI) window presented to a user during or subsequent to a method for determining a financial advance based on hydrocarbon well royalties according to the present disclosure.

FIG. 4 is a schematic diagram of all or a portion of a computing system that can be used for the operations described in association with any of the computer-implemented processes described herein.

### DETAILED DESCRIPTION

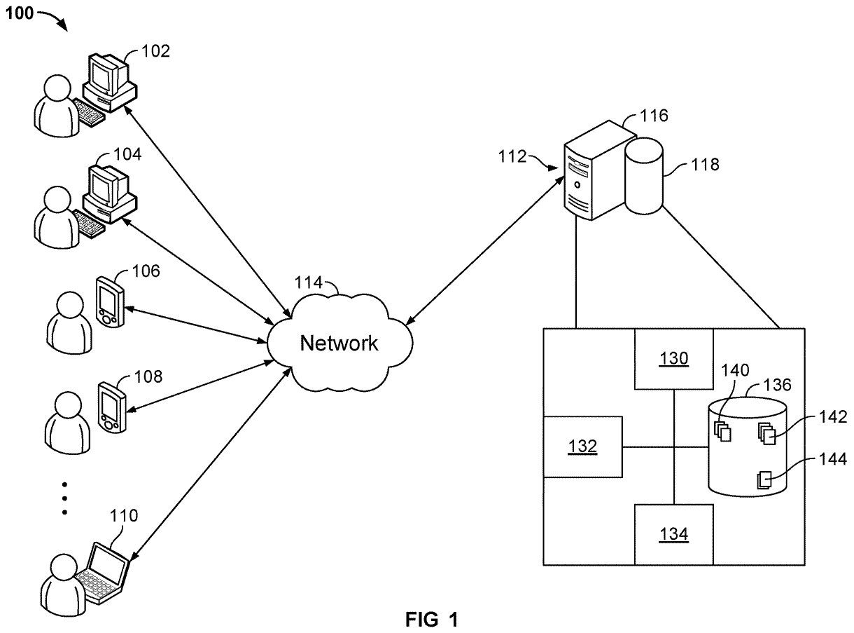

FIG. 1 illustrates an example distributed network architecture 100 that includes one or more client devices and one or more server devices that is operable to determine a financial advance based on hydrocarbon well royalties. The network architecture 100 includes a number of client devices 102, 104, 106, 108, 110 communicably connected to a structured data processing server system 112 (“server system 112”) by a network 114. The server system 112 includes a server device 116 and a data store 118. The server device 116 executes computer instructions (e.g., all or a part of a financial advance solver application) stored in the data store 118 to perform functions of a financial advance service. For example, in some aspects, the financial advance service may be a subscription service available to the client devices 102, 104, 106, 108, and 110 (and other client devices) by an owner or operator of the server system 112. In some aspects, the server system 112 may be owned or operated by a third party (e.g., a collocation server system) that hosts the financial advance service for the owner or operator of the financial advance service.

Generally, and as described in more detail herein, all or a part of the distributed network architecture 100 is operable to determine a financial advance based on hydrocarbon well royalties that are owned, all or partially, by a particular entity (such as a human owner or business entity). For example, the distributed network architecture 100 is operable to determine, based on one or more databases or data stores that include such information, a complete or substantially complete itemization of a royalty owner's interests in or to multiple hydrocarbon producing wells (e.g., oil producing, gas producing, or both). In some aspects, fractional ownerships for the owner are determined and accounted for. In addition, the distributed network architecture 100 is operable to determine a monetary value of the owner's royalty interests based on, for example, historical hydrocarbon production from the multiple hydrocarbon producing wells, as well as predicted future hydrocarbon production from the multiple hydrocarbon producing wells. In some aspects, the distributed network architecture 100 is operable to execute an underwriting process that compares, for example, the monetary value of the owner's royalty interests to particular underwriting criteria in order to set an amount of a financial advance to the owner.

Users of the client devices 102, 104, 106, 108, 110 access the server system 112 to participate in the financial advance service. For example, the client devices 102, 104, 106, 108, 110 can execute web browser applications that can be used to access the financial advance service. In another example, the client devices 102, 104, 106, 108, 110 can execute software applications that are specific to the financial advance service (e.g., as “apps” running on smartphones). In other words, all of the financial advance service may be hosted and executed on the server system 112. Or in alternative aspects, a portion of the financial advance service may execute on the client devices 102, 104, 106, 108, and 110 (e.g., to receive and transmit information entered by a user of such client devices and/or to display output data from the financial advance service to the user).

In some implementations, the client devices 102, 104, 106, 108, 110 can be provided as computing devices such as laptop or desktop computers, smartphones, personal digital assistants, portable media players, tablet computers, or other appropriate computing devices that can be used to communicate with an electronic social network. In some implementations, the server system 112 can be a single computing device such as a computer server. In some implementations, the server system 112 can represent more than one computing device working together to perform the actions of a server computer (e.g., cloud computing). In some implementations, the network 114 can be a public communication network (e.g., the Internet, cellular data network, dialup modems over a telephone network) or a private communications network (e.g., private LAN, leased lines).

As illustrated in FIG. 1, the server system 112 (e.g., the server device 116 and data store 118) includes one or more processing devices 132, a financial advance solver 130, one or more memory modules 136, and an interface 134. Generally, each of the components of the server system 112 are communicably coupled such that the one or more processing devices 132 may execute the financial advance solver 130 and access and manipulate data stored in the one or more memory modules 136. Data to be output from the server system 112, or data to be input to the server system 112, may be facilitated with the interface 134 that communicably couples the server system 112 to the network 114.

As illustrated in this example, the one or more memory modules 136 may store or reference one or more data sets. An example data set includes royalty payment data 140. For example, royalty payment data 140 can include data associated with the payment of royalties from one or more payors (e.g., entities responsible for paying royalties to royalty interest owners) as well as data associated with the payment of royalties to one or more payees (e.g., royalty interest owners). Royalty payment data 140 can also include payment data itself, such as monetary amounts paid by the payor to the payee and hydrocarbon volumes (e.g., barrels of oil, cubic feet of natural gas) for which the payments are made. Royalty payment data 140 can also include identifying information on the hydrocarbon production wells from which the minerals (e.g., oil, gas, or both) are produced. The well identifying information can include, for instance, API well numbers, well names, lease names, or other information.

Another data set includes hydrocarbon production data 142. For example, hydrocarbon production data 142 can include historical production data from one or more of the hydrocarbon production wells, either individually or as lease-level production information. Hydrocarbon production data 142 can also include geological data regarding one or more subterranean reservoirs into which the hydrocarbon production wells are drilled.

Another data set includes underwriting data 144. For example, underwriting data 144 can include one or more parameters or requirements that are used in an underwriting process by the distributed network architecture 100. Example parameters or requirements can include, for instance, loan-to-value limits, royalty ownership portfolio limits, as well as regulatory requirements. Regulatory requirements can include categories based on a remaining quantity of minerals (e.g., of oil and gas) within an owner's interest and also based on a likelihood that the minerals will be produced. The categories include, for example: (1) P1, which is “proved reserves” or minerals that have a 90% chance of being recovered; (2) P2, which is “probable” reserves” or minerals that have a 50% chance of being recovered; and (3) P3, which is “possible reserves” or minerals that have a 10% chance of being recovered. In the P1 category, there are three sub-categories. The first sub-category is Proved Developed Producing (PDP) reserves, which are defined as an estimated remaining quantities of oil and gas anticipated to be economically producible, as of a given date, by application of development projects to known accumulations under existing economic and operating conditions. The second sub-category is Proved Developed Non-Producing (PDNP) reserves, which are proven reserves that can be expected to be recovered through existing wells and existing equipment and operating methods. The third sub-category is Proved Undeveloped (PUDs) reserves, which are proven reserves that are expected to be recovered from new wells on undrilled acreage or from existing wells where a relatively major expenditure is required for completion.

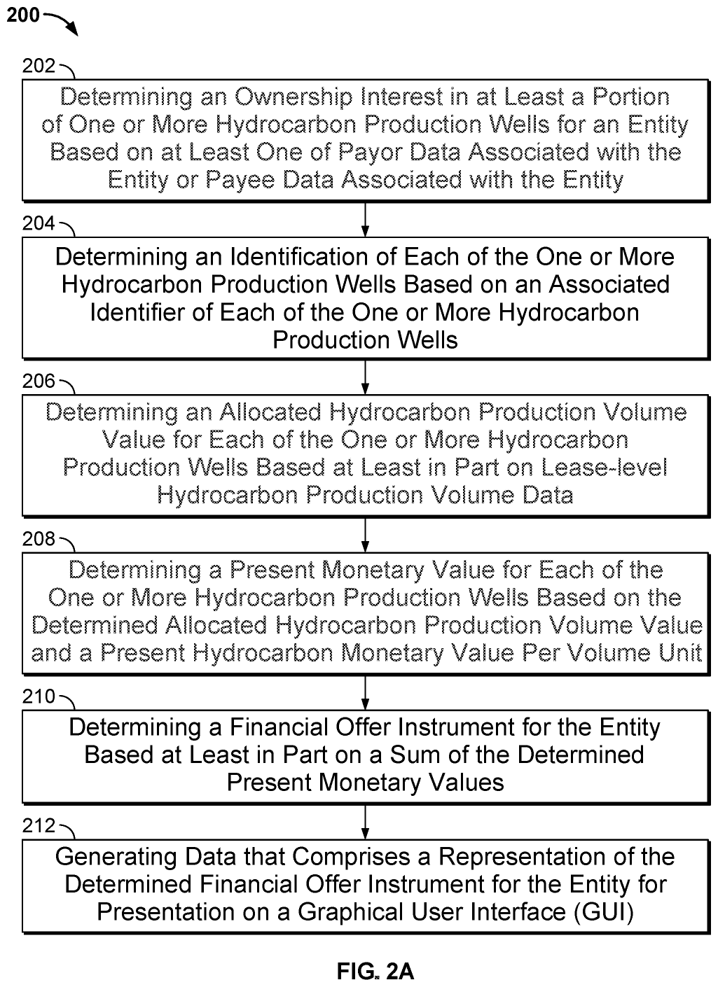

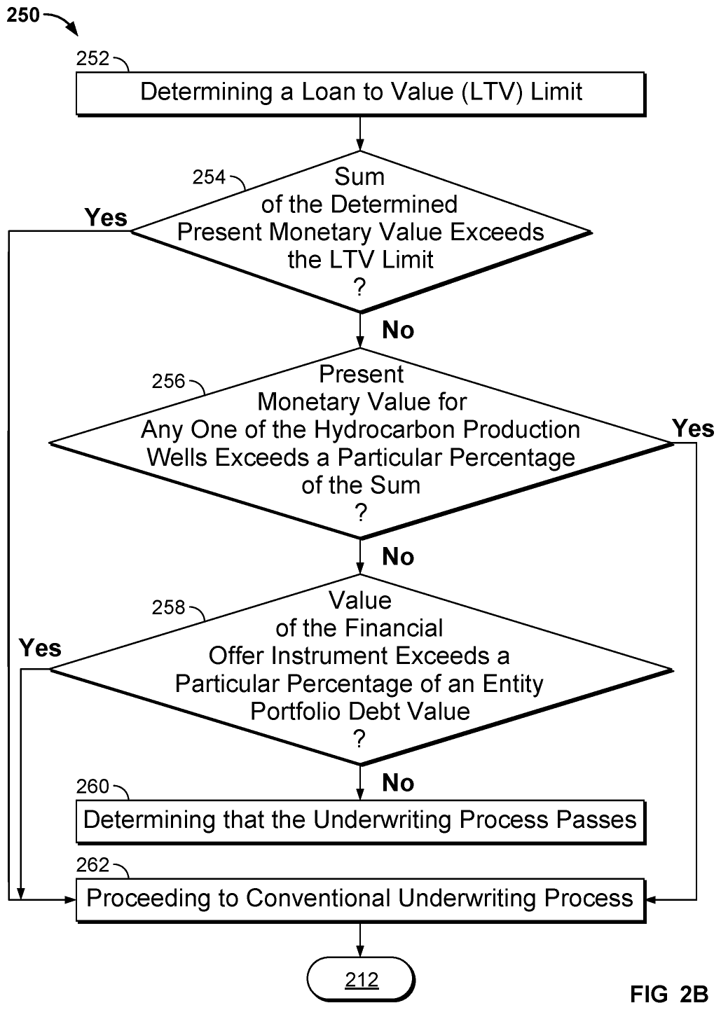

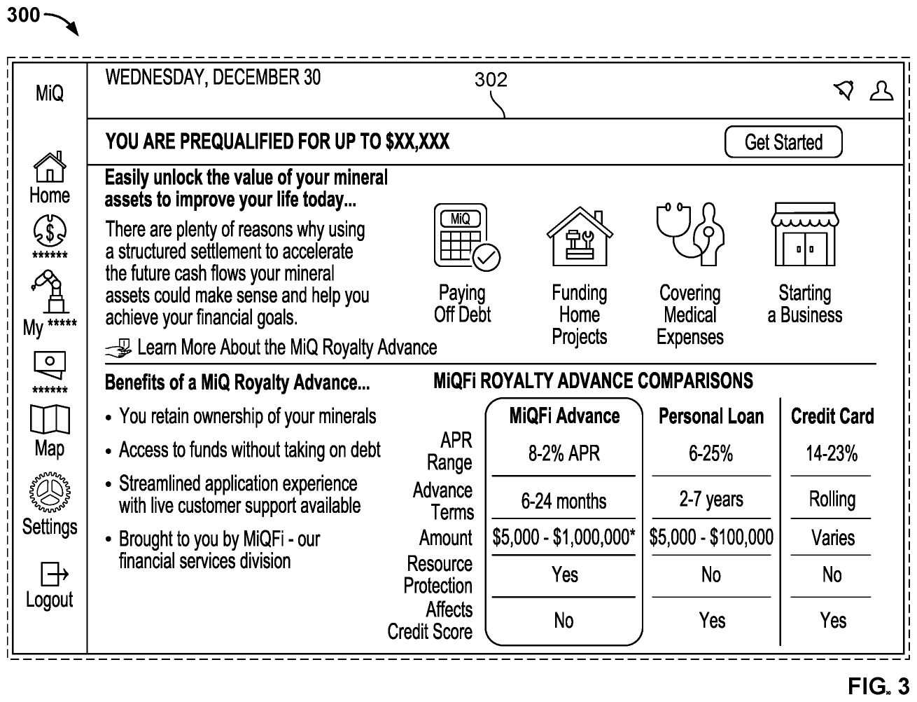

FIGS. 2A-2B illustrate flowcharts that describe methods for determining a financial advance based on hydrocarbon well royalties that are owned, all or partially, by a particular entity according to the present disclosure. For example, FIG. 2A illustrates an example implementation of a method 200 for determining a financial advance based on hydrocarbon well royalties, while FIG. 2B illustrates an example implementation of a method 250 for step 210 of method 200 shown in FIG. 2A. In some aspects, the example methods shown in FIGS. 3A-3B can be executed with or by the financial advance solver 130 shown in FIG. 1.

Method 200 can begin at step 202, which includes determining an ownership interest in at least a portion of one or more hydrocarbon production wells for an entity based on at least one of payor data associated with the entity or payee data associated with the entity. For example, in some aspects, payor or payee data can be determined according to, for instance, a payment document (such as a royalty payment document). A royalty payment document can be stored as royalty payment data 140 and include information such as payor information (typically a well operator or other entity that is responsible for facilitating payment of hydrocarbon royalties to an owner of an interest in the hydrocarbons) and payee information (the owner of the interest). Other information from a royalty payment document can include an identification of an amount (percentage or fraction) of ownership interest of the entity. Other information from a royalty payment document can include an identification of the one or more hydrocarbon production wells in which the entity owns an interest, such as by API number, well name, lease name, or other identifying data. In some aspects, royalty payment documents can be obtained from private sources or public sources and recorded as royalty payment data 140. Alternatively, such information can be provided during step 202 (or before) by, for instance, a payee or a payor (or other entity) in response to a request for such information or otherwise. Of course, step 202 be iterated multiple times such that multiple ownership interests from multiple entities can be identified or determined.

Method 200 can continue at step 204, which includes determining an identification of each of the one or more hydrocarbon production wells based on an associated identifier of each of the one or more hydrocarbon production wells. For example, in some aspects, the associated identifier of each of the one or more hydrocarbon production wells can be determined or identified by the royalty payment documents. Alternatively or additionally, the associated identifier of each of the one or more hydrocarbon production wells can be determined or identified based on a correlation between payor information and payee information. Alternatively or additionally, the associated identifier of each of the one or more hydrocarbon production wells can be determined or identified based on royalty payment documents cross-associated or checked with regulatory information (e.g., information filed at a state's regulatory office under state law, such as the Texas Railroad Commission). In some aspects, the associated identifier can be an American Petroleum Institute (API) number that is unique to each hydrocarbon producing well.

Method 200 can continue at step 206, which includes determining an allocated hydrocarbon production volume value for each of the one or more hydrocarbon production wells based at least in part on lease-level hydrocarbon production volume data. For example, in some aspects, hydrocarbon production volume data can be determined based on reported production associated with the associated identifier that is unique to each hydrocarbon producing well. In some aspects, for example, public production data is available on a per well basis, meaning that the determination of how much hydrocarbon production volume a well has historically produced is straightforward. In such cases, the reported production for the well or wells can be determined in step 206.

However, in some aspects, reported production (e.g., data reported to one or more regulatory agencies and part of hydrocarbon production data 142) is not reported on a per well basis but instead is reported on a per lease basis. Each lease may include multiple (tens, hundreds, or otherwise) of hydrocarbon production wells. Thus, reported production (e.g., pending or sales production or both) may be an aggregate production of the multiple hydrocarbon production wells. Further, the identified ownership entity from step 202 may only have an ownership interest (all or partial) in some number less than a total of the multiple hydrocarbon production wells on the lease. Thus, step 206 can include determining hydrocarbon production data for each well in which the entity has an ownership interest based on an allocated production model.

In some aspects, the allocation model identifies a lease ID, such as from the royalty payment document or from regulatory information that associates the lease ID with API numbers of wells on the lease. The allocation model also identifies periodic hydrocarbon production values associated with the lease ID, along with first and last periods of hydrocarbon production values associated with the lease ID and the wells associated with the lease ID. The allocation model can then allocate the periodic hydrocarbon production values among the identified wells on the lease on a periodic basis. For example, as noted while the regulatory data may include hydrocarbon production values at a lease level rather than for individual wells associated with the selected lease, the allocation model can determine allocated well-by-well periodic production values from the lease level data.

In some aspects, the allocation model determines historical allocated production on a well-by-well basis as well as predicted future production on a well-by-well basis. For example, when more than one active well is contained in a lease-level aggregate hydrocarbon production value for any particular period (e.g., month, year), the allocation is based on either a predicted production value from a decline curve for each well, or for proportional allocation to the well if no decline curve yet exists for the well, or some combination of these two. In some aspects, a decline curve may be assigned to a well once the periodic production declines from one period to a next period for the well. Thus, the assigned decline curve (which can be determined or based on geological data regarding one or more subterranean reservoirs into which the hydrocarbon production wells are drilled in the hydrocarbon production data 142) can be used by the allocation model to predict future periodic (e.g., monthly) hydrocarbon production volume for the one or more wells in which the entity has an ownership interest.

Method 200 can continue at step 208, which includes determining a present monetary value for each of the one or more hydrocarbon production wells based on the determined allocated hydrocarbon production volume value and a present hydrocarbon monetary value per volume unit. For example, the present monetary value can be determined according to a volume amount of the hydrocarbon production as determined in step 206 multiplied by a present hydrocarbon monetary value per volume unit, such as per barrel (if the produced mineral is oil) or per cubic feet (if the produced mineral is gas). In some aspects, the present monetary value for each of the one or more hydrocarbon production wells can be determined according to an amount assigned to past or historical production and an amount (e.g., a discounted amount) assigned to future or predicted hydrocarbon production.

Method 200 can continue at step 210, which includes determining a financial offer instrument for the entity based at least in part on a sum of the determined present monetary values. In some aspects, the financial offer instrument can be a loan amount for which the entity is, e.g., pre-qualified based on the sum of the determined present monetary values.

In some aspects, step 210 includes an underwriting process. An example implementation of the underwriting process is shown in FIG. 2B and method 250. Method 250 can begin at step 252, which includes determining a loan to value (LTV) limit. For example, in this case, a LTV limit can be the largest allowable ratio of a financial offer to the monetary value of the sum of the determined present monetary values. The LTV limit can be pre-determined or calculated in step 252, e.g., based on the identity of the owner of the hydrocarbon royalty interests or other information.

Method 250 can continue at step 254, which includes a determination of whether a sum of the determined present monetary value exceeds the LTV limit. For example, a comparison is made between the sum of the determined present monetary values determined in step 208 and the LTV limit determined in step 252. In some aspects, step 254 includes a determination of whether the PDP of the owned interests are greater than the LTV limit. Further, in some cases, step 254 includes a determination of whether the PDP of the owned interests (in sum if more than one well) is at least four times greater than the LTV limit. If the determination in step 254 is yes, then method 250 continues to step 262, which includes proceeding to conventional underwriting process. Thus, if the condition in step 254 is not met, while the underwriting process might not have failed, the process continues conventionally, e.g., with only human oversight and review.

If the determination in step 254 is no, then method 250 can continue at step 256, which includes a determination of whether a present monetary value for any one of the hydrocarbon production wells exceeds a particular percentage of the sum. For example, as part of the underwriting process of method 250, a check may be performed to ensure that no single well of many wells of an entity's ownership is too large, thereby skewing the total sum of the determined present monetary values. In some aspects, step 256 includes a comparison of the PDP for each well in which the entity has an ownership interest against a particular percentage (e.g., 75%) of the sum of the determined present monetary values. If the determination in step 256 is yes, then method 250 continues to step 262, which includes proceeding to conventional underwriting process. Thus, if the condition in step 256 is also not met, while the underwriting process might not have failed, the process continues conventionally, e.g., with only human oversight and review.

If the determination in step 256 is no, then method 250 can continue at step 258, which includes a determination of whether a value of the financial offer instrument exceeds a particular percentage of an entity portfolio debt value. For example, as part of the underwriting process of method 250, a check may be performed to ensure that the value of the financial offer instrument does not make a total outstanding loan portfolio of the owner entity exceed a predetermined limit. For example, the particular percentage (e.g., 10%) may be set to ensure that the proposed financial offer in method 250 does not cause a total outstanding loan amount to go over the entity's portfolio debt value. If the determination in step 258 is yes, then method 250 continues to step 262, which includes proceeding to conventional underwriting process. Thus, if the condition in step 258 is also not met, while the underwriting process might not have failed, the process continues conventionally, e.g., with only human oversight and review

If the determination in step 258 is no, then method 250 can continue at step 260, which includes determining that the underwriting process passes. For example, based on the conditions in steps 254-258 being met, the financial advance solver 130 can determine that the financial offer instrument passes the underwriting process and can be presented.

Returning to FIG. 2A, method 200 can continue from method 250 to step 212, which includes generating data that comprises a representation of the determined financial offer instrument for the entity for presentation on a graphical user interface (GUI). For example, upon approval of the underwriting process by method 250, the financial offer instrument for the entity can be provided to or otherwise presented to the entity with the ownership interest(s) in one or more hydrocarbon production wells. Turning briefly to FIG. 3, this figure illustrates an example GUI window 300 presented to the owner entity with the financial offer instrument 302 that has been determined according to methods 200 and 250.

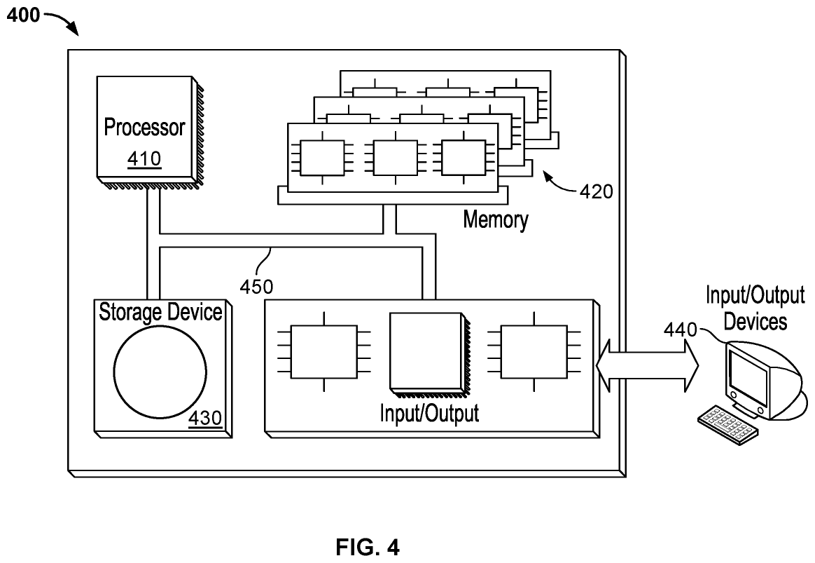

FIG. 4 is a schematic diagram of a computer system 400. The system 400 can be used for the operations described in association with any of the computer-implemented methods described previously, for example as or as part of the structured data processing server system 112 or other data processing systems described herein. The system 400 is intended to include various forms of digital computers, such as laptops, desktops, workstations, personal digital assistants, servers, blade servers, mainframes, and other appropriate computers. The system 400 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of embodiments have been described. Nevertheless, it will be understood that various modifications may be made without departing from the spirit and scope of what is described. For example, the steps of the exemplary flow charts in FIGS. 2A-2C may be performed in other orders, some steps may be removed, and other steps may be added. Accordingly, other embodiments are within the scope of the following claims.

What is claimed is:

1. A computer-implemented method performed with a computing system that comprises one or more hardware processors, comprising:
determining, with the one or more hardware processors, an ownership interest in at least a portion of one or more hydrocarbon production wells for an entity based on at least one of payor data associated with the entity or payee data associated with the entity;
determining, with the one or more hardware processors, an identification of each of the one or more hydrocarbon production wells based on an associated identifier of each of the one or more hydrocarbon production wells;
determining, with the one or more hardware processors, an allocated hydrocarbon production volume value for each of the one or more hydrocarbon production wells based at least in part on lease-level hydrocarbon production volume data;
determining, with the one or more hardware processors, a present monetary value for each of the one or more hydrocarbon production wells based on the determined allocated hydrocarbon production volume value and a present hydrocarbon monetary value per volume unit;
determining, with the one or more hardware processors, a financial offer instrument for the entity based at least in part on a sum of the determined present monetary values; and
generating, with the one or more hardware processors, data that comprises a representation of the determined financial offer instrument for the entity for presentation on a graphical user interface (GUI).

2. The computer-implemented method of claim 1, wherein determining the ownership interest comprises at least one of:
identifying, with the one or more hardware processors, the payor data from a royalty payment record associated at least one payor; or
identifying, with the one or more hardware processors, the payee data from a royalty payment record associated the entity.

3. The computer-implemented method of claim 1, wherein the associated identifier comprises an American Petroleum Institute (API) number uniquely associated with each of the one or more hydrocarbon production wells.

4. The computer-implemented method of claim 1, further comprising:
identifying, with the one or more hardware processors, the at least one of payor data associated with the entity or payee data associated with the entity from a royalty statement associated with the entity; and
identifying, with the one or more hardware processors, the associated identifier of each of the one or more hydrocarbon production wells from the royalty statement associated with the entity.

5. The computer-implemented method of claim 4, further comprising:
determining, with the one or more hardware processors, at least one additional payor data associated with the entity based on the at least one of payor data associated with the entity; and
determining, with the one or more hardware processors, an associated identifier of at least one additional hydrocarbon production well associated with the entity based on the

6. The computer-implemented method of claim 1, wherein the determined allocated hydrocarbon production volume value for each of the one or more hydrocarbon production wells comprises historical allocated hydrocarbon production volume value for each of the one or more hydrocarbon production wells.

7. The computer-implemented method of claim 6, further comprising determining, with the one or more hardware processors, the historical allocated hydrocarbon production volume value for each of the one or more hydrocarbon production wells by:
identifying, with the one or more hardware processors, a lease identifier associated with the lease-level hydrocarbon production volume data;
determining, with the one or more hardware processors, a plurality of hydrocarbon production wells associated with the lease identifier, the plurality of hydrocarbon production wells including the one or more hydrocarbon production wells;
determining, with the one or more hardware processors, a decline curve model for the lease-level hydrocarbon production volume data associated with the lease identifier;
modeling, with the one or more hardware processors, aggregated monthly well-level hydrocarbon production values with the determined decline curve model; and
determining, with the one or more hardware processors, the historical allocated hydrocarbon production volume value for each of the one or more hydrocarbon production wells based on the aggregated monthly well-level hydrocarbon production values and the decline curve model.

8. The computer-implemented method of claim 7, wherein the determined allocated hydrocarbon production volume value for each of the one or more hydrocarbon production wells further comprises predicted allocated hydrocarbon production volume value for each of the one or more hydrocarbon production wells.

9. The computer-implemented method of claim 8, wherein the decline curve model is defined, at least in part, by a maximum periodic hydrocarbon production value and at least one decline rate.

10. The computer-implemented method of claim 8, further comprising:
determining, with the one or more hardware processors, the predicted allocated hydrocarbon production volume value for each of the one or more hydrocarbon production wells based at least in part on the decline curve model.

11. The computer-implemented method of claim 1, wherein determining the financial offer instrument for the entity comprises executing, with the one or more hardware processors, an underwriting process.

12. The computer-implemented method of claim 11, wherein the underwriting process comprises:
determining, with the one or more hardware processors, a loan to value (LTV) limit;
determining, with the one or more hardware processors, that the sum of the determined present monetary value exceeds the LTV limit;
determining, with the one or more hardware processors, that the present monetary value for any one of the one or more hydrocarbon production wells does not exceed a particular percentage of the sum of the determined present monetary values;
determining, with the one or more hardware processors, that a value of the financial offer instrument does not exceed a particular percentage of an entity portfolio debt value; and
determining, with the one or more hardware processors, that the underwriting process passes.

13. The computer-implemented method of claim 12, wherein generating data that comprises the representation of the determined financial offer instrument for the entity is based on the determination that the underwriting process passes.

14. A computing system, comprising:
one or more memory modules;
one or more hardware processors communicably coupled to the one or more memory modules, the one or more hardware processors configured to execute instructions stored on the one or more memory modules to perform operations comprising:
determining an ownership interest in at least a portion of one or more hydrocarbon production wells for an entity based on at least one of payor data associated with the entity or payee data associated with the entity;
determining an identification of the one or more hydrocarbon production wells based on an associated identifier of each of the one or more hydrocarbon production wells;
determining an allocated hydrocarbon production volume value for each of the one or more hydrocarbon production wells based at least in part on lease-level hydrocarbon production volume data;
determining a present monetary value for each of the one or more hydrocarbon production wells based on the determined allocated hydrocarbon production volume value and a present hydrocarbon monetary value per volume unit;
determining a financial offer instrument for the entity based at least in part on a sum of the determined present monetary values; and
generating data that comprises a representation of the determined financial offer instrument for the entity for presentation on a graphical user interface (GUI).

15. The computing system of claim 14, wherein the operation of determining the ownership interest comprises at least one of:
identifying the payor data from a royalty payment record associated at least one payor; or
identifying the payee data from a royalty payment record associated the entity.

16. The computing system of claim 14, wherein the associated identifier comprises an American Petroleum Institute (API) number uniquely associated with each of the one or more hydrocarbon production wells.

17. The computing system of claim 14, wherein the operations further comprise:
identifying the at least one of payor data associated with the entity or payee data associated with the entity from a royalty statement associated with the entity; and
identifying the associated identifier of each of the one or more hydrocarbon production wells from the royalty statement associated with the entity.

18. The computing system of claim 17, wherein the operations further comprise:
determining at least one additional payor data associated with the entity based on the at least one of payor data associated with the entity; and
determining an associated identifier of at least one additional hydrocarbon production well associated with the entity based on the

19. The computing system of claim 14, wherein the determined allocated hydrocarbon production volume value for each of the one or more hydrocarbon production wells comprises historical allocated hydrocarbon production volume value for each of the one or more hydrocarbon production wells.

20. The computing system of claim 19, wherein the operations further comprise determining the historical allocated hydrocarbon production volume value for each of the one or more hydrocarbon production wells by:
identifying a lease identifier associated with the lease-level hydrocarbon production volume data;
determining a plurality of hydrocarbon production wells associated with the lease identifier, the plurality of hydrocarbon production wells including the one or more hydrocarbon production wells;
determining a decline curve model for the lease-level hydrocarbon production volume data associated with the lease identifier;
modeling aggregated monthly well-level hydrocarbon production values with the determined decline curve model; and
determining the historical allocated hydrocarbon production volume value for each of the one or more hydrocarbon production wells based on the aggregated monthly well-level hydrocarbon production values and the decline curve model.

21. The computing system of claim 20, wherein the determined allocated hydrocarbon production volume value for each of the one or more hydrocarbon production wells further comprises predicted allocated hydrocarbon production volume value for each of the one or more hydrocarbon production wells.

22. The computing system of claim 21, wherein the decline curve model is defined, at least in part, by a maximum periodic hydrocarbon production value and at least one decline rate.

23. The computing system of claim 21, wherein the operations further comprise:
determining, with the one or more hardware processors, the predicted allocated hydrocarbon production volume value for each of the one or more hydrocarbon production wells based at least in part on the decline curve model.

24. The computing system of claim 14, wherein the operation of determining the financial offer instrument for the entity comprises executing, with the one or more hardware processors, an underwriting process.

25. The computing system of claim 24, wherein the underwriting process comprises:
determining a loan to value (LTV) limit;
determining that the sum of the determined present monetary value exceeds the LTV limit;
determining that the present monetary value for any one of the one or more hydrocarbon production wells does not exceed a particular percentage of the sum of the determined present monetary values;
determining that a value of the financial offer instrument does not exceed a particular percentage of an entity portfolio debt value; and
determining that the underwriting process passes.

26. The computing system of claim 25, wherein the operation of generating data that comprises the representation of the determined financial offer instrument for the entity is based on the determination that the underwriting process passes.
